(19) United States
(12) Patent Application Publication
(10) Pub. No.: US 2020/0109023 A1
(43) Pub. Date: Apr. 9, 2020

(54) OPTICAL FIBER STORAGE METHOD, DELIVERY METHOD, AND OPTICAL FIBER WINDING BOBBIN

(71) Applicant: SUMITOMO ELECTRIC INDUSTRIES, LTD., Osaka-shi, Osaka (JP)

(72) Inventor: Naruki KOSHIMIZU, Utsunomiya-shi, Tochigi (JP)

(73) Assignee: SUMITOMO ELECTRIC INDUSTRIES, LTD., Osaka-shi, Osaka (JP)

(21) Appl. No.: 16/617,786

(22) PCT Filed: Mar. 29, 2018
(86) PCT No.: PCT/JP2018/013366

§ 371 Date: Nov. 27, 2019

(30) Foreign Application Priority Data
Jun. 1, 2017 (JP) 2017-109040

(51) Int. Cl. B65H 49/08; G02B 6/44

(52) U.S. Cl. CPC B65H 49/08; B65H 2701/32; G02B 6/4457

(57) ABSTRACT

It is possible to wind an optical fiber up to the vicinity of an edge of a flange of a bobbin, and prevent a winding collapse of the optical fiber without increasing work steps. In a state in which the optical fiber coated with a coating resin is wound around the bobbin, a resin film that does not include a plasticizer is covered so as to be in direct contact with an outer circumference of the optical fiber, and the optical fiber is stored.

### TECHNICAL FIELD

The present invention relates to an optical fiber storage method, a delivery method, and an optical fiber winding bobbin.

This application claims priority based on Japanese Patent Application No. 2017-109040 filed on Jun. 1, 2017, the contents of which are incorporated herein by reference in its entirety.

### BACKGROUND ART

An optical fiber storage method is known, which stores the optical fiber in a state of being wound around a bobbin. In such a storage method, the optical fiber wound around the bobbin may be stored while an outer circumference of the optical fiber is packed with a protective film so as to prevent the optical fiber from being contaminated by dust when the optical fiber is stored in the state of being wound around the bobbin, or to prevent direct contact with the optical fiber when it is in the process of moving the stored bobbin (for example, see PTL 1).

### CITATION LIST

### Patent Literature

PTL 1: Japanese Unexamined Patent Application Publication No. 2012-220548

PTL 2: Japanese Unexamined Patent Application Publication No. 9-197146

### SUMMARY OF INVENTION

An optical fiber storage method according to an aspect of the present disclosure includes, in a state in which an optical fiber coated with a coating resin is wound around a bobbin, covering with a resin film that does not contain a plasticizer so as to be in direct contact with an outer circumference of the optical fiber, and storing the optical fiber.

An optical fiber delivery method according to an aspect of the present disclosure includes, in a state in which an optical fiber coated with a coating resin is wound around a bobbin, covering with a resin film that does not contain a plasticizer so as to be in direct contact with an outer circumference of the optical fiber, and delivering the optical fiber.

An optical fiber winding bobbin according to an aspect of the present disclosure is an optical fiber winding bobbin including an optical fiber coated with a coating resin, a bobbin around which the optical fiber is wound, and a resin film that covers the optical fiber and the bobbin,

in which the bobbin includes a cylindrical drum around which the optical fiber is wound, and flanges provided on both sides of the drum,

a diameter of the outer circumference of the optical fiber wound around the drum is the same as a diameter of the flanges, and

the outer circumference of the optical fiber and edges of the flanges are covered in direct contact with the resin film, and the resin film does not contain a plasticizer.

### BRIEF DESCRIPTION OF DRAWINGS

FIG. 1 is a perspective view showing an example of an optical fiber winding bobbin according to the present embodiment.

FIG. 2 is a cross-sectional perspective view showing an example of a structure of the optical fiber wound around the bobbin in FIG. 1.

FIG. 3 is a perspective view showing an optical fiber wound around a bobbin with a storage method and a delivery method according to comparative example.

### MODE TO EMBODY THE INVENTION

### Technical Problem

For example, in the protective film disclosed in PTL 1, a plasticizer is mixed in a film base material in order to have a function of shielding ultraviolet rays. However, when an optical fiber is directly packed with a film mixed with the plasticizer, the plasticizer in the film may be transferred to the fiber at a location where the film and the coating resin of the optical fiber are in contact with each other, which results in possibility that the coating resin of the optical fiber is deteriorated. For this reason, the film and the optical fiber may be spaced apart to prevent the direct contact, but there is a risk of winding collapse of the optical fiber due to vibration or the like during the delivery or the operation of moving the bobbin. It is conceivable to interpose an air cushion or the like between the film and the optical fiber in order to prevent the winding collapse, but this accordingly increases work steps. In either case, the optical fiber cannot be wound up to the vicinity of the edge of the flange of the bobbin.

PTL 2 discloses a method of packing an optical fiber for pneumatic feeding using a conductive protective film to prevent electrical charging of the optical fiber for pneumatic feeding when the protective film is removed. Since the conductive protective film uses conductive materials and conductive additives, it costs extra cost, but the conductive protective film may not be necessarily used for a general optical fiber that is not used for pneumatic feeding.

An objective of the present disclosure is to provide an optical fiber storage method, a delivery method, and an optical fiber winding bobbin, which can enable the optical fiber to be wound up to the vicinity of the edges of the flanges of the bobbin, and can also prevent the winding collapse of the optical fiber without increasing the work steps.

### Advantageous Effects of Disclosure

According to the present disclosure, it is possible to wind the optical fiber up to the vicinity of the edges of the flanges of the bobbin, while also preventing the winding collapse of the optical fiber without increasing the work steps.

### DESCRIPTION OF EMBODIMENTS

First, embodiments of the present disclosure will be listed and described.

An optical fiber storage method according to an embodiment of the present disclosure may include

(1) in a state in which an optical fiber coated with a coating resin is wound around a bobbin, covering with a resin film that does not contain a plasticizer so as to be in direct contact with an outer circumference of the optical fiber, and storing the optical fiber.

According to the above storage method, it is possible to store the optical fiber in a state of being wound up to the vicinity of the edges of the flanges of the bobbin, while also preventing the winding collapse of the optical fiber without increasing the work steps.

An optical fiber delivery method according to an embodiment of the present disclosure may include

(2) in a state in which an optical fiber coated with a coating resin is wound around a bobbin, covering with a resin film that does not contain a plasticizer so as to be in direct contact with an outer circumference of the optical fiber, and delivering the optical fiber.

According to the above delivery method, it is possible to deliver the optical fiber in a state of being wound up to the vicinity of the edge of the flange of the bobbin, while also preventing the winding collapse of the optical fiber without increasing the work steps.

An optical fiber winding bobbin according to an embodiment of the present disclosure is

(3) an optical fiber winding bobbin including an optical fiber coated with a coating resin, a bobbin around which the optical fiber is wound, and a resin film that covers the optical fiber and the bobbin,

in which the bobbin includes a cylindrical drum around which the optical fiber is wound, and flanges provided on both sides of the drum,

a diameter of the outer circumference of the optical fiber wound around the drum is the same as a diameter of the flanges, and

the outer circumference of the optical fiber and edges of the flanges are covered in direct contact with the resin film, and the resin film does not contain a plasticizer.

The optical fiber winding bobbin described above may prevent the winding collapse of the optical fiber during storage or delivery without increasing the work steps.

### DETAILED DESCRIPTION OF EMBODIMENTS

Specific examples of an optical fiber storage method, a delivery method, and an optical fiber winding bobbin according to an embodiment of the present disclosure will be described below with reference to the drawings.

In addition, the disclosure is not limited to these embodiments, but is intended to be indicated by the claim, and includes all modifications within the scope and meaning equivalent to the claims.

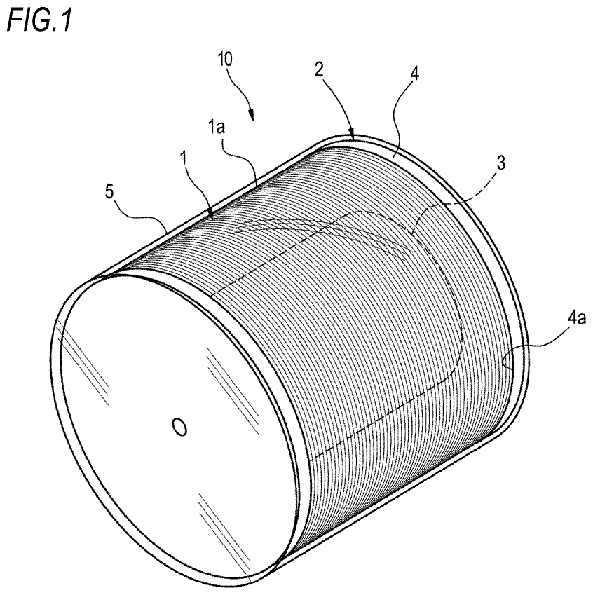

An example of an optical fiber winding bobbin according to the present embodiment is shown in FIG. 1. As shown in FIG. 1, an optical fiber winding bobbin 10 includes an optical fiber 1 coated with a coating resin, a bobbin 2 around which the optical fiber 1 is wound, and a resin film 5 that covers the optical fiber 1 and the bobbin 2. The bobbin 2 has a cylindrical drum 3, and disk-shaped flanges 4 respectively provided on both ends of the cylindrical drum 3. A diameter of an outer circumference of the optical fiber 1 wound around the drum 3 and a diameter of the flanges 4 are the same. Note that the “same” does not mean the sameness in a strict sense, but indicates a range that is considered to be the same as long as the range can achieve the effect of the disclosure.

In addition, in the optical fiber winding bobbin 10, the outer circumference 1a of the optical fiber 1 and the edges 4a of the flange 4 are covered and in direct contact with the resin film 5 that does not include a plasticizer.

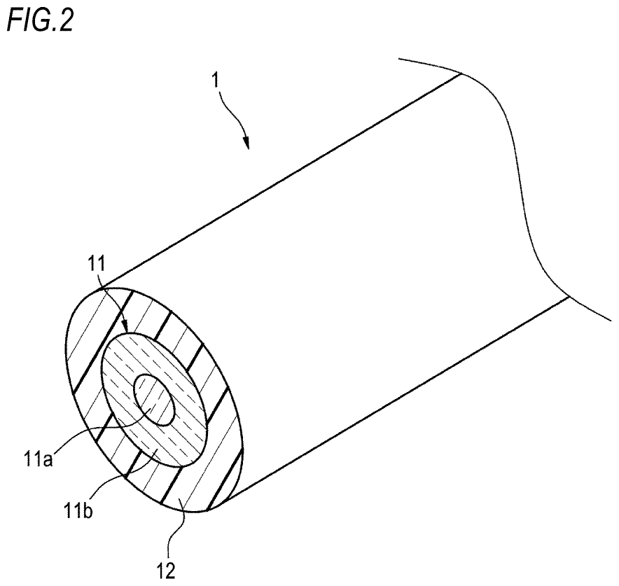

For example, as shown in FIG. 2, the optical fiber 1 includes a glass fiber 11 including a core 11a and a clad 11b, and an outer circumference of the glass fiber 11 is coated with a coating resin 12 (outer coating). The optical fiber 1 is manufactured by drawing the glass fiber 11 from a glass preform and coating a coating resin 12 around the glass fiber 11, for example. The resin composition forming the coating resin 12 contains the following base resin. Although the base resin is not particularly limited as long as it has radiation curability, for example, a resin containing an oligomer, a monomer, and a photoinitiator is preferable.

Examples of the oligomer include urethane acrylate, epoxy acrylate, or a mixture thereof. Examples of the urethane acrylate include those obtained by reacting a polyol compound, a polyisocyanate compound, and a hydroxyl group-containing acrylate compound. Examples of the polyol compound include polytetramethylene glycol, polypropylene glycol, and the like. Examples of the polyisocyanate compound include 2,4-tolylene diisocyanate, isophorone diisocyanate, and the like. Examples of the hydroxyl group-containing acrylate compound include 2-hydroxy acrylate, 2-hydroxybutyl acrylate, 1,6-hexanediol monoacrylate, pentaerythritol triacrylate, 2-hydroxypropyl acrylate, and the like.

Examples of the monomer include N-vinyl monomers having a cyclic structure, such as N-vinylpyrrolidone, N-vinylcaprolactam, and acryloylmorpholine. In addition, monofunctional monomers such as isobornyl acrylate, tricyclodecanyl acrylate, benzyl acrylate, dicyclopentanyl acrylate, 2-hydroxyethyl acrylate, phenoxyethyl acrylate, polypropylene glycol monoacrylate, and polyfunctional monomers such as polyethylene glycol diacrylate or tricyclodecanediyl dimethylene diacrylate are used.

Examples of the photoinitiator include 1-hydroxycyclohexyl phenyl ketone, 2,2-dimethoxy-2-phenylacetophenone, 1-(4-isopropylphenyl)-2-hydroxy-2-methylpropan-1-one, 2,4,4-trimethylpentylphosphine oxide, and the like. Further, an antioxidant, a photosensitizer, and the like may be added. The coating resin 12 may be formed of a plurality of layers.

(Storage Method of Optical Fiber According to Present Embodiment)

With the optical fiber storage method according to the present embodiment, the optical fiber 1 is stored as follows.

As shown in FIG. 1, the optical fiber 1 is prepared in a state of being overlapped and wound up to the vicinity of the edge 4a of the flange 4 of the bobbin 2. Then, the resin film 5 that does not include a plasticizer is covered so as to be in direct contact with the outer circumference 1a of the optical fiber 1. The optical fiber winding bobbin 10 in a state of being coated with the resin film 5 that does not include a plasticizer as described above is stored by, for example, storing it in a predetermined storage location or the like.

As a material of the resin film 5 that does not include a plasticizer, for example, low density polyethylene, high density polyethylene, EVA resin, polypropylene, polyethylene terephthalate, polyvinyl alcohol, polyamide, and the like may be used, and in particular, low-density polyethylene and high-density polyethylene, which are widely distributed, are inexpensive and preferred. In addition, the plasticizer refers to a substance added in order to give a flexibility or to make it easy to process. Examples of plasticizers include dioctyl phthalate (DOP), diisononyl phthalate (DINP), diisodecyl phthalate (DIDP), dibutyl phthalate (DBP), dioctyl adipate (DOA), diisononyl adipate (DINA), adipine Di-n-octyl acid (DNOA), di-(2-ethylhexyl) adipate (DEHA), trioctyl trimellitate (TOTM), tricresyl phosphate (TCP), acetyl tributyl citrate (ATBC), epoxidized soybean oil (ESBO), epoxidized linseed oil (ELSO), dibutyl sebacate (DBS), diacetyllauroylglycerol (DALG), azelaic acid ester, maleic acid ester, benzoic acid ester, and the like.

(Delivery Method of Optical Fiber According to Present Embodiment)

As shown in FIG. 1, the optical fiber 1 is prepared in a state of being overlapped and wound up to the vicinity of the edge 4a of the flange 4 of the bobbin 2. Then, the resin film 5 that does not include a plasticizer is covered so as to be in direct contact with the outer circumference 1a of the optical fiber 1. The optical fiber winding bobbin 10 in a state of being coated with the resin film 5 that does not include a plasticizer as described above is delivered.

(Storage Method and Delivery Method of Comparative Example)

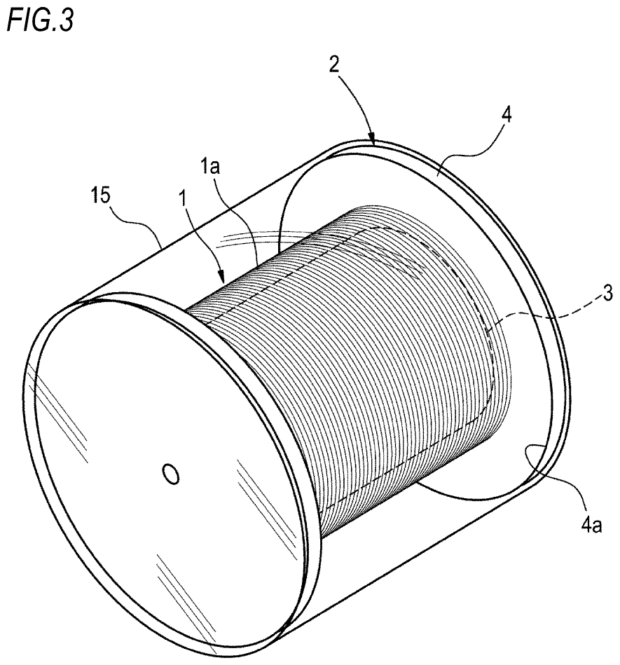

FIG. 3 shows an optical fiber wound around a bobbin with an optical fiber storage method and a delivery method of a comparative example using a resin film that includes a plasticizer.

In the case of the comparative example using the resin film 15 that includes a plasticizer, the plasticizer in the film 15 that includes the plasticizer may be transferred to the fiber 1 at a location where the film 15 including the plasticizer and the coating resin 12 of the optical fiber 1 are in contact with each other, and accordingly, there is a possibility that the coating resin 12 of the optical fiber 1 is deteriorated. Accordingly, as shown in FIG. 3, the resin film 15 that includes the plasticizer and the outer circumference of the optical fiber 1 are spaced apart from each other so as not to come into direct contact with each other. Accordingly, an amount of winding of the optical fiber 1 is smaller than that of the optical fiber winding bobbin 10 of FIG. 1.

When the resin film 15 that includes the plasticizer is in close contact with the outer circumference 1a of the optical fiber 1, it is possible to prevent the optical fiber 1 from being unwound. However, in the comparative example, due to a wide gap between the outer circumference 1a of the optical fiber 1 and the resin film 15 including the plasticizer, there is a possibility that the vibration is applied to the bobbin to cause the winding collapse of the optical fiber 1 when the bobbin is moved during storage or when the bobbin is delivered.

In order to prevent the winding collapse described above, it is conceivable that a cushioning material such as an air cushion is interposed between the outer circumference 1a of the optical fiber 1 and the plastic film 15 that includes the plasticizer, but the cost of the cushioning material is required and this increases the work steps. Further, when the cushioning material is used, the amount of the winding of the optical fiber 1 is reduced by at least the thickness of the cushioning material.

According to the storage method or delivery method according to the present embodiment, it is possible to store or deliver the optical fiber 1 in a state of being wound to overlap up to the vicinity of the edge 4a of the flange 4 of the bobbin 2. As a result, the amount of winding of the optical fiber 1 around the bobbin 2 may be increased by about 40%, for example, as compared with the comparative example as described above, and accordingly, more optical fibers 1 may be stored or delivered than the conventional cases.

Further, since the resin film 5 that does not include a plasticizer is covered so as to be in direct contact with the outer circumference 1a of the optical fiber 1, the resin film 5 that does not include the plasticizer and the outer circumference 1a of the optical fiber 1 are in close contact, and it is possible to prevent the winding collapse of the optical fiber 1 due to vibration when the bobbin is moved during storage or when the bobbin is delivered.

Further, since it is not necessary to use a cushioning material such as an air cushion for preventing the winding collapse, the cost of the cushioning material is not required, and also the operation of interposing the cushioning material is not necessary.

As described above, while the invention has been described in detail and with reference to specific embodiments thereof, it will be apparent to those skilled in the art that various changes and modifications can be made without departing from the spirit and scope of the invention. Further, the number, the position, the shape, and the like of the above-described constituent members are not limited to the above embodiments, and can be changed to a suitable number, a position, a shape, and the like for implementing the present disclosure.

### REFERENCE SIGNS LIST

1: optical fiber
2: bobbin
3: drum
4: flange
5: resin film that does not include a plasticizer
10: optical fiber winding bobbin
11: glass fiber
11: a core
11: b clad
12: coating resin (outer coating)
15: resin film that includes a plasticizer

1. An optical fiber storage method, comprising, in a state in which an optical fiber coated with a coating resin is wound around a bobbin, covering with a resin film that does not contain a plasticizer so as to be in direct contact with an outer circumference of the optical fiber, and storing the optical fiber.

2. An optical fiber delivery method, comprising, in a state in which an optical fiber coated with a coating resin is wound around a bobbin, covering with a resin film that does not contain a plasticizer so as to be in direct contact with an outer circumference of the optical fiber, and delivering the optical fiber.

3. An optical fiber winding bobbin comprising an optical fiber coated with a coating resin, a bobbin around which the optical fiber is wound, and a resin film that covers the optical fiber and the bobbin, wherein
the bobbin includes a cylindrical drum around which the optical fiber is wound, and flanges provided on both sides of the drum,
a diameter of the outer circumference of the optical fiber wound around the drum is the same as a diameter of the flanges, and
the outer circumference of the optical fiber and edges of the flanges are covered in direct contact with the resin film, and the resin film does not contain a plasticizer.
